(19) United States
(12) Patent Application Publication
(10) Pub. No.: US 2004/0180253 A1
(43) Pub. Date: Sep. 16, 2004

(54) Fuel cell power system

(76) Inventor: John M. Fisher, Spokane, WA (US)

Correspondence Address: WELLS ST. JOHN P.S., 601 W. FIRST AVENUE, SUITE 1300, SPOKANE, WA, 99201, US

(21) Appl. No.: 10/388,104

(22) Filed: Mar. 12, 2003

(51) Int. Cl. H01M 8/24; H01M 8/04

(52) U.S. Cl. 429/34; 429/22; 429/26

(57) ABSTRACT

A fuel cell power system is disclosed and which includes a housing defining an internal cavity; and a plurality of fuel cell modules are received within the cavity and which are electrically coupled together, to provide, when operational, at least about a 1,000 watt electrical output, and wherein the individual fuel cell modules may be electrically decoupled from the remaining fuel cell modules and removed from the cavity, while the remaining fuel cell modules continue to operate, and wherein the fuel cell power system weighs less than about 150 pounds.

### TECHNICAL FIELD

The present invention relates to a fuel cell power system, and more specifically to a fuel cell power system having hand manipulatable modules which may be removed from the fuel cell power system during operation, and which further is compact, and lightweight.

### BACKGROUND OF THE INVENTION

The advantages of employing substantially self-hydrating fuel cell modules in variously designed fuel cell power systems have been disclosed in U.S. Pat. Nos. 6,030,718, and 6,468,682, the teachings of which are incorporated by reference herein.

One of the salient aspects of these earlier patents is to provide an ion exchange membrane fuel cell, having multiple modules, and which each enclose a membrane electrode diffusion assembly. In these prior art assemblies, at least one of the modules can be easily removed from the ion exchange membrane fuel cell by hand while the remaining modules continue to operate. In U.S. Pat. No. 6,030,718, a fuel cell module arrangement is disclosed and wherein the fuel cell modules are provided with a cathode air flow which removes a preponderance of the heat energy generated during fuel cell operation. In contrast, U.S. Pat. No. 6,468,682 discloses a fuel cell module arrangement wherein the respective fuel cell modules are provided with a bifurcated air flow which regulates the operational temperature of the fuel cell module. In particular, the fuel cell module which is disclosed in this previous patent is provided with an anode heat sink, and wherein a portion of the air flow provided to the fuel cell module passes over the anode heat sink to remove a preponderance of the heat energy generated during fuel cell module operation.

While each of these prior art fuel cell power systems and fuel cell module designs have operated with a great deal of success, the inventors have attempted to improve upon these inventive concepts by focusing further investigation on providing a lightweight, relatively compact fuel cell power system which can be utilized in a wide variety of different commercial and other industrial environments.

Accordingly, a fuel cell power system which achieves the benefits to be derived from the aforementioned prior art teachings but which avoids the perceived detriments and shortcomings individually associated with stack-type fuel cell designs is the subject matter of the present invention.

### SUMMARY OF THE INVENTION

One aspect of the present invention is to provide a fuel cell power system which includes a housing defining an internal cavity; and a plurality of fuel cell modules received within the cavity and which are electrically coupled together, and which provide, when operational, at least about a 1000 watt electrical output, and wherein the individual fuel cell modules may be electrically decoupled from the remaining fuel cell modules and removed from the cavity, while the remaining fuel cell modules continue to operate, and wherein the fuel cell power system weighs less than about 150 pounds.

Yet another aspect of the present invention relates to a fuel cell power system which includes, a housing defining a cavity, and which includes an air plenum which is coupled in fluid flowing relation relative to the cavity; an air movement assembly coupled in fluid flowing relation relative to the air plenum, and which circulates ambient air through the cavity; a plurality of fuel cell modules operably received within the cavity and which, when rendered operational, generate heat energy which is removed from the respective fuel cell modules by way of the ambient air circulated through the air plenum, and wherein the respective fuel cell modules weigh less than about 12 pounds each, and are electrically coupled together, and wherein the respective fuel cell modules can be readily electrically decoupled, and removed from the cavity of the housing, while the remaining fuel cell modules continue in operation; a DC to DC converter borne by the housing and which is electrically coupled with the respective fuel cell modules and with a load having a demand; and an electrically reconfigurable, and inverter compatible, control electronics assembly which is borne by the housing and which can be accessed from a location which is outside of the cavity, and wherein the control electronics assembly is coupled in controlling relation relative to the respective fuel cell modules, and with the DC to DC converter, and which further provides user controls for initiating, terminating, and monitoring fuel cell power system operation, and wherein the fuel cell power system delivers at least about 1000 watts of electrical power to the load.

A further aspect to the present invention relates to a fuel cell power system which includes a housing defining an internal cavity and which is operable to move ambient air in a predetermined circulation pattern within the internal cavity, and wherein the housing occupies a space of less than about 8 cubic feet; a plurality of fuel cell modules which are received within the cavity of the housing and which, when rendered operational, produces an electrical power output of less than about 1000 watts, and heat energy, and wherein the ambient air circulating in the housing has the effect of removing a preponderance of the heat energy from the plurality of fuel cell modules and delivering the heat energy to ambient, and wherein the plurality of fuel cell modules collectively weigh less than about 72 pounds and occupy a space of less than about 1.2 cubic feet within the internal cavity of the housing; a DC to DC converter borne by the housing and electrically coupled with the respective fuel cell modules and with a load having a demand; and an electrically reconfigurable and inverter compatible, control electronics assembly which is borne by the housing and which is coupled in controlling relation relative to the respective fuel cell modules, and which further can be electrically coupled with at least one other fuel cell power system, and wherein the fuel cell power system weighs less than about 150 pounds.

These and other aspects of the present invention will be discussed in greater detail hereinafter.

### BRIEF DESCRIPTION OF THE DRAWINGS

Preferred embodiments of the invention are described below with reference to the following accompanying drawings.

FIG. 1 is a perspective, side elevation view of a fuel cell power system of the present invention with some surfaces removed to show the structure thereunder.

FIG. 2 is a perspective, fragmentary, exploded view of a portion of a fuel cell power system of the present invention.

FIG. 3 is a fragmentary, perspective side elevation view of a portion of the fuel cell power system of the present invention.

FIG. 4 is an environmental, perspective side elevation view of the fuel cell power system of the present invention as seen in a typical operational arrangement.

FIG. 5 is a side elevation view of the fuel cell power system of the present invention with some underlying surfaces shown in phantom lines.

FIG. 6 is a rear elevation view of the fuel cell power system of the present invention.

FIG. 7 is a perspective, side elevation view of an ion exchange membrane fuel cell module which finds usefulness in the fuel cell power system of the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

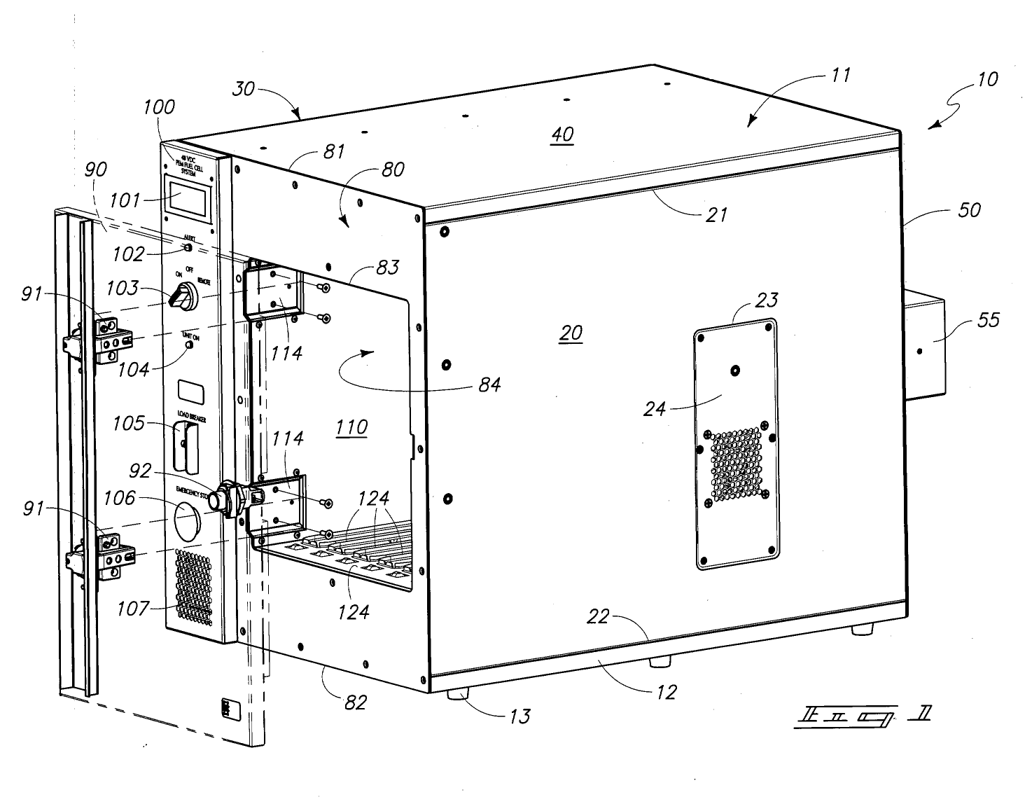

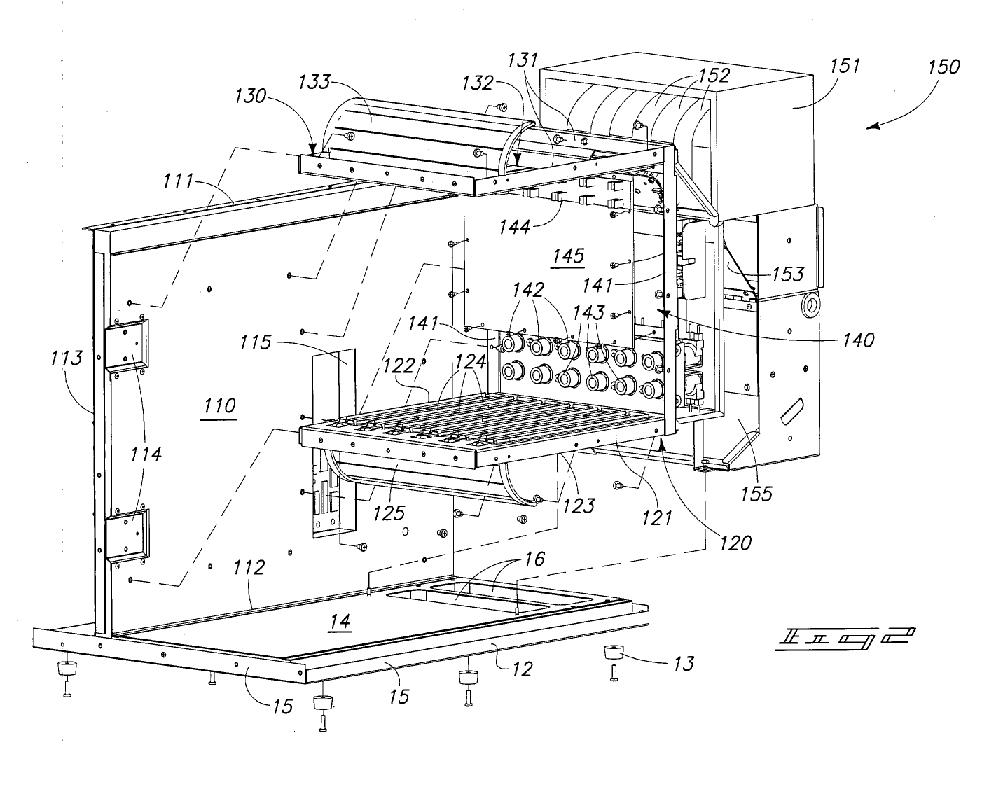

The fuel cell power system of the present invention is generally indicated by the numeral 10 in FIG. 1 and following. As seen in FIG. 1, the fuel cell power system 10 includes a housing 11 having a base portion 12 which rests on an adjacent supporting surface. A plurality of supporting members 13 are positioned about the base portion and are operable to locate the base portion in spaced relation relative to an adjacent supporting surface. The base portion 12 has an inwardly facing surface 14 (FIG. 2) and further is defined by a peripheral edge 15. A pair of apertures 16, as seen in FIG. 2, extend through the base portion 12 and communicate to ambient.

The housing 11 further has a first sidewall 20, which has top and bottom peripheral edges 21 and 22, respectively. It will be seen that the bottom peripheral edge 22 matingly couples with the peripheral edge 15 of the base portion 12. The first sidewall 20 extends substantially normally upwardly relative to the inwardly facing surface 14. As illustrated in FIG. 1, an aperture 23 is formed in a predetermined location in the first sidewall and a vented cover plate 24 substantially occludes the aperture 23 and can be removed therefrom in order to allow access to the subassemblies therebeneath.

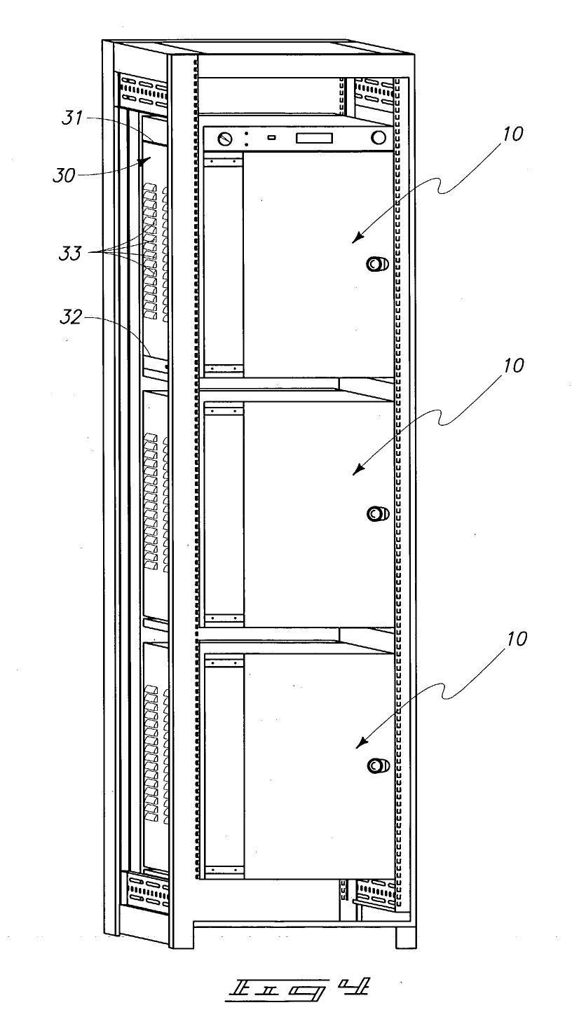

The housing 11 includes a second sidewall 30 (FIG. 4) which is located in predetermined, substantially parallel spaced relation relative to the first sidewall 20 and which also extends substantially normally upwardly relative to the inwardly facing surface 14 of the base portion 12. The second sidewall 30 has a top peripheral edge 31 and a bottom peripheral edge 32 (FIG. 4) and which matingly couples with the peripheral edge 15 of the base portion 12. As best seen by reference to FIG. 4, the second sidewall 30 includes a plurality of vents 33 which allow for the convenient movement of air in and out of an electronics bay which lies immediately beneath the second sidewall 30 and which will be discussed in greater detail hereinafter. It should be understood that the second sidewall 30 is easily removed from the housing 11 in order to permit convenient access to the areas therebeneath. The housing 11 further includes a top surface or sidewall 40 and which joins the first and second sidewalls 20 and 30 together. This is best seen in FIG. 1.

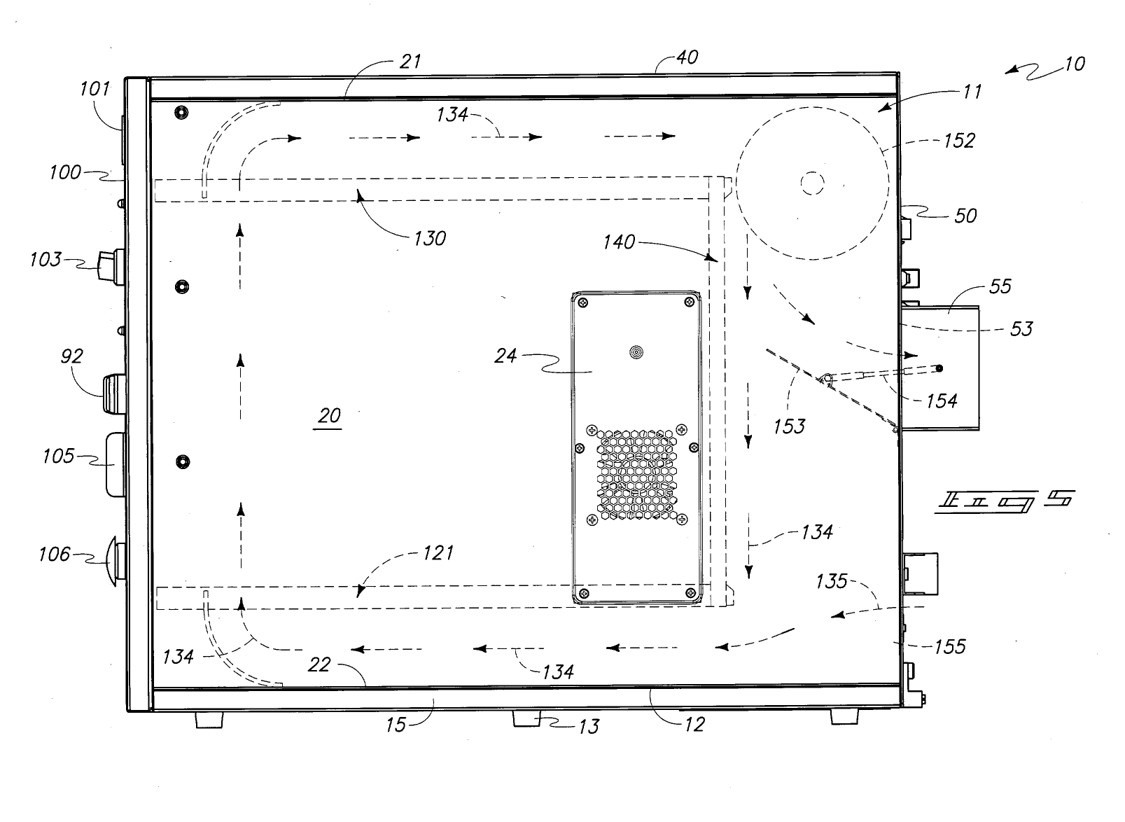

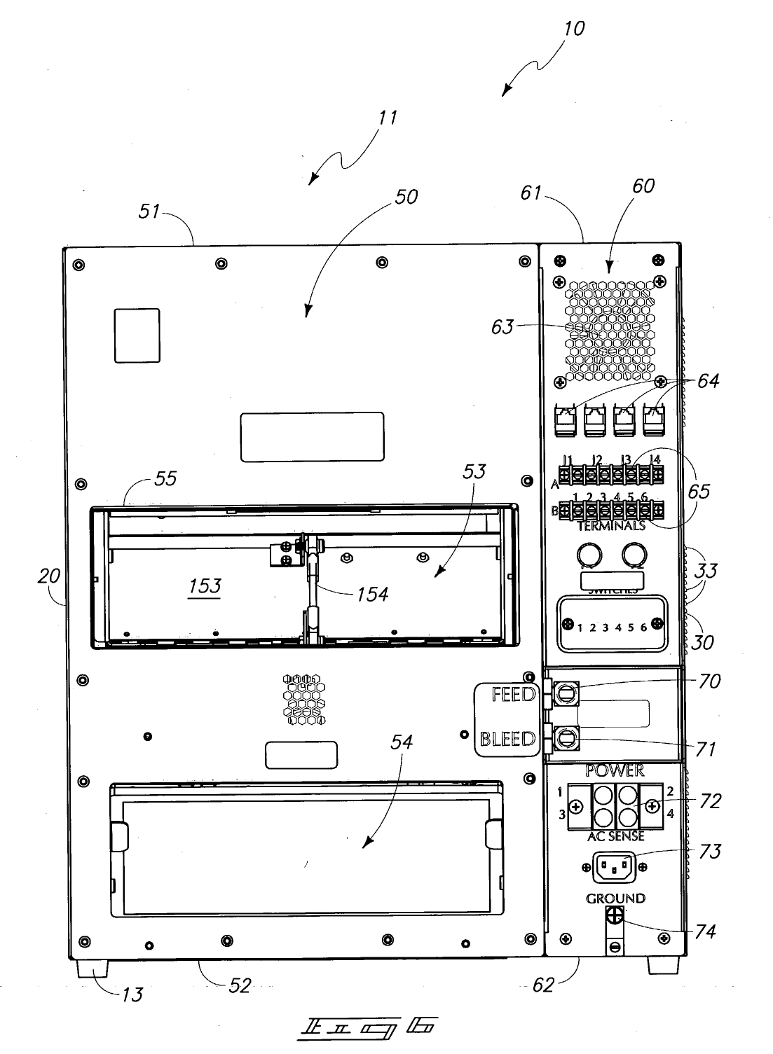

Referring now to FIGS. 5 and 6, it will be seen that the housing 11 includes a first rear sidewall 50 which has a top peripheral edge 51, and a bottom peripheral edge 52. The first sidewall 20 releasably mates with first rear sidewall. Further the base 12 is affixed to the bottom peripheral edge 52. The first rear sidewall 50 has a first aperture 53 which is formed therein and which is positioned approximately centrally thereof, and as seen in FIG. 6, is narrowly rectangular in shape. Still further, and located beneath the first aperture 53 and adjacent to the base portion 12 is a second aperture 54. As seen in the side elevation view of FIG. 5, a substantially circumscribing sidewall or passageway 55 extends normally outwardly relative to the first rear sidewall 50 and substantially surrounds the first aperture 53.

A second rear sidewall 60 is disposed in substantially the same plane as the first rear sidewall 50, and has a top peripheral edge 61 which releasably mates with the top surface or sidewall 40, and further has an opposite, bottom peripheral edge 62 which is releasably affixed to the peripheral edge 15 of the base portion 12. Still further, the second rear sidewall 60 releasably mates with the second sidewall 30. The second rear sidewall has an air passageway 63 formed therein and which permits a fan located therebeneath, (not shown) to facilitate air movement through an electronics bay which will be discussed in greater detail hereinafter. The air passageway 63 is located in a position adjacent to the top sidewall 40. Immediately below the air passageway 63 is a plurality of modular jacks 64, one of which may include an Ethernet jack. These various modular jacks 64 releasably electrically couple with mating jack assemblies and which will allow the fuel cell power system 10 to be coupled with adjacent fuel cell power systems 10 and further to remote locations as will be described hereinafter. Located immediately below the plurality of modular jacks 64 is a plurality of screw type electrical connections which further allow a user to electrically couple the fuel cell power system 10 with remote locations and with other electrical assemblies. As will be seen in FIG. 6, the fuel cell power system 10 includes a fluid intake 70, and a fluid exhaust coupler 71 and which are mounted on the second rear sidewall 60. The fluid intake coupler 70 is operable to deliver a source of fuel gas, such as hydrogen, to the fuel cell modules which will be enclosed within the housing 11 and which will be discussed in greater detail hereinafter. Yet further, the fluid exhaust coupler 71 is coupled in fluid flowing relation relative to the same fuel cell modules and which facilitates the removal of any unused hydrogen, and waste by-products, such as water, and the like, from the fuel cell power system 10. The second rear sidewall 60 further includes a first power output terminal 72 and a second power output plug 73. These two assemblies permit electrical power to be removed from the fuel cell power system 10, and sent to a load (not shown). Immediately below the power output plug 73, is a ground screw 74 which will permit a user to electrically ground the fuel cell power system 10 appropriately.

Referring now to FIG. 1, the fuel cell power system 10 includes a front sidewall or surface, and which is generally indicated by the numeral 80. The front sidewall 80 has a top peripheral edge 81 which is matingly coupled to the top sidewall 40, and an opposite, bottom peripheral edge 82 which is affixed to the peripheral edge 15 of the base portion 12. Still further, the front sidewall matingly couples with the first sidewall 20. An aperture 83 is formed therein, and which permits access to a housing cavity 84 which is defined, in part, by the first sidewall 20, the top sidewall 40, the first rear sidewall 50, and the front sidewall 80. The housing cavity 84 encloses a plurality of ion exchange membrane fuel cell modules as will be discussed in greater detail hereinafter. The housing 11 further includes a door 90 (shown in phantom lines), and which is operable to selectively occlude the aperture 83 and prevent access to the housing cavity 84. The door 90 includes a pair of hinges 91 which are affixed to an internal supporting wall which will be discussed in greater detail hereinafter. The door 90 further includes a latch assembly 92, which is operable to releasably engage the front sidewall 80 thereby securing the door in an occluding position relative to the aperture 83.

The fuel, cell power system 10 of the present invention includes a control panel which is generally indicated by the numeral 100 and which is disposed in substantially the same plane as the door 90 when the door is positioned in occluding relation relative to the aperture 83. The control panel includes a liquid crystal display 101 which is operable to convey information regarding the operational status of the fuel cell power system 10. The liquid crystal display can display various combinations of alpha-numeric characters. Immediately below the liquid crystal display 101 is a visual warning light 102 which is operable to visually alert an operator regarding a malfunction in the fuel cell power system 10. Immediately below the visual warning light 102 is a selector switch 103 which provides a means by which an operator may select various modes of operation for the fuel cell power system 10. In this regard, the fuel cell power system 10 is operable to work in a local mode or in a remote mode. In the remote mode, the fuel cell power system 10 can be controlled from a remote location by way of a telecommunications connection. Positioned on the control panel 100 and below, the selector switch 103 is a visual status light 104 which provides a visual indication regarding whether the fuel cell power system 10 is energized. The control panel 100 further includes a load breaker switch 105 which permits an operator to electrically connect or disconnect the fuel cell power system 10 relative to the load that it is servicing. The fuel cell power system 10 further includes an emergency stop switch 106 which allows an operator to rapidly de-energize or shut down the fuel cell power system 10 in the event of an emergency. Located below the emergency stop switch 106 is an air passageway 107. This air passageway permits ambient air to pass therethrough under the influence of a fan (not shown). The movement of ambient air through this air passageway 107 allows for the dissipation of heat generated in an electrical bay which will be discussed in greater detail hereinafter. As earlier discussed, this heat energy is exhausted to ambient by way of the air passageway 63 which is formed in the second rear sidewall 60.

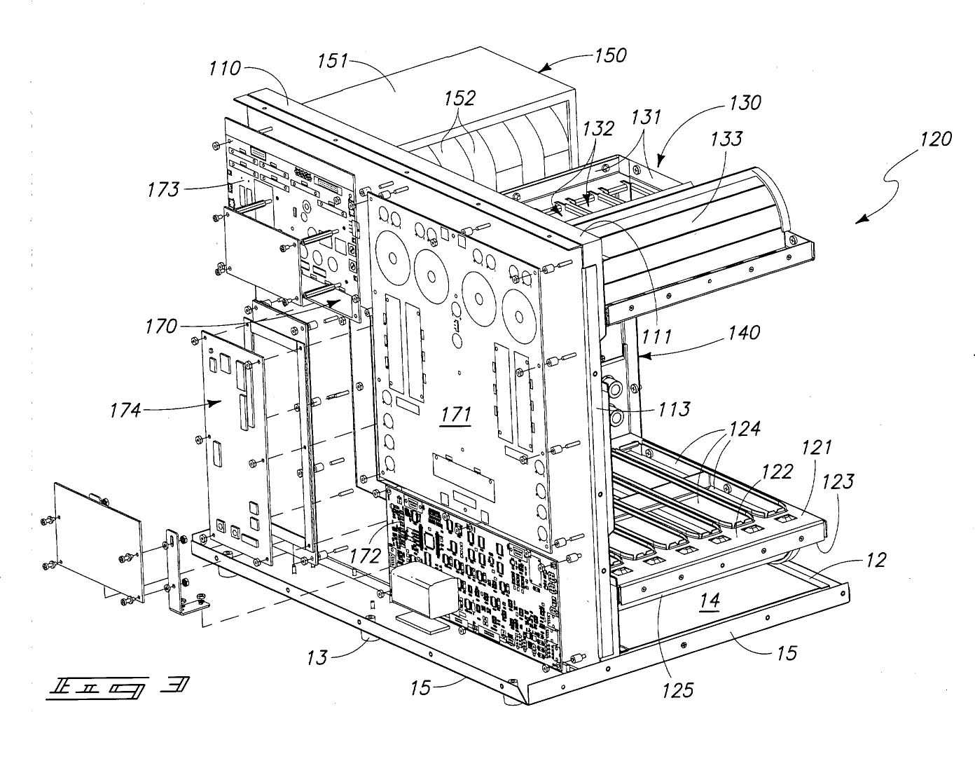

Referring now to FIGS. 2 and 3, an internal supporting wall or partition 110 is mounted on the inwardly facing surface 14, of the base portion 12 and extends substantially normally upwardly therefrom. This internal supporting wall 100 has a top peripheral edge 111 which matingly rests against the top sidewall 40 and further defines, in part, the internal cavity 84. Still further, the internal supporting wall 110 has a bottom peripheral edge 112 which is suitably affixed by various fastening techniques to the base portion 12. The internal supporting wall further has a forward facing peripheral edge 113. Formed adjacent to the forward facing peripheral edge 113 are a pair of spaced apart hinge cavities 114 which matingly receive the respective hinges 91. As illustrated most clearly in FIG. 2, an aperture 115 is formed in the internal supporting wall 110, and which permits electrical conduits to pass therethrough and into the electrical bay which will be discussed below.

Referring still to FIG. 2, the fuel cell power system 10 of the present invention includes a fuel cell module support frame 120 which is positioned within the cavity 84 which is defined by the housing 11. The fuel cell module support frame 120 includes a lower shelf portion 121 which is operable to support individual ion exchange fuel cell modules in an operative position relative to the cavity 84. These fuel cell modules will be discussed hereinafter. The lower shelf portion 121 includes an upper facing surface 122 which supports the respective fuel cell modules, and an opposite lower facing surface 123. As seen by reference to FIGS. 2 and 3, it will be recognized that a plurality of the passageways 124 are formed in the lower shelf portion and which permits a stream of ambient air to pass therethrough. This ambient air supplies the oxidant source for the ion exchange membrane fuel cell modules which are supported thereon. Still further, this ambient air stream removes heat energy generated by the individual fuel cell modules and eventually exhausts it to the ambient environment. As seen most clearly by reference to FIG. 2, a lower air plenum sidewall 125 depends downwardly from the lower facing surface 123 and is affixed to the inwardly facing surface 14 of the base portion 12. This lower air plenum sidewall forms a portion of an air plenum which will be discussed hereinafter and which is operable to effectively deliver the ambient air stream to the individual fuel cell modules.

The fuel cell module support frame 120 further includes an upper frame portion which is generally indicated by the numeral 130 and which is disposed in predetermined substantially parallel spaced relation relative to the lower shelf portion 121. As will be recognized from the exploded view of FIG. 2 when assembled, the lower shelf portion 121 is disposed in substantially parallel spaced relation relative to the base portion 12 and the upper frame portion 130 will be disposed in predetermined substantially parallel spaced relation relative to the top sidewall 40 (FIG. 5). As seen in FIG. 2, the upper frame portion 130 comprises a plurality of frame members 131 which form a substantially square or rectangular shaped frame and an aperture 132 is defined between the plurality of frame members. An upper air plenum sidewall 133 is mounted on the upper frame portion 130, and is operable to rest against or adjust to the top sidewall 40. When assembled, a portion of an air plenum 134 is defined between the upper frame portion 130, and the top sidewall 40, and the lower shelf portion 121 and the base portion 12. This is best seen by a study of FIGS. 3 and 5, respectively.

The fuel cell module support frame 120 includes a rear wall portion 140 which is substantially vertically disposed and which extends substantially normally upwardly relative to the lower shelf portion 121, and further is coupled to the upper frame portion 130. The rear wall portion 140 is defined, in part, by a pair of substantially vertically oriented support members 141. The pair of vertically oriented support members 141 support a manifold which includes a plurality of fluid supply couplers 142, and a plurality of fluid exhaust couplers 143. These respective supply and exhaust couplers are operable to releasably mate in fluid flowing relation with corresponding fluid couplers which are mounted on the individual ion exchange membrane fuel cell modules which will be discussed in greater detail hereinafter. Yet further, the rear wall portion 140 supports a DC bus 144 in an appropriate orientation and which permits the individual fuel cell modules to releasably electrically couple thereto. The DC bus is electrically coupled to the electrical bay which will be discussed in greater detail hereinafter. A support plate 145 is mounted on or otherwise supported between the respective vertically oriented members 141. The rear wall portion 140 defines, in part, the air plenum 134.

Referring still to FIGS. 2 and 5, it will be seen that the fuel cell power system 10 of the present invention includes an air movement assembly which is generally indicated by the numeral 150. As will be recognized by a study of those drawings, the air movement assembly is positioned rearwardly relative to the housing 11, and is in a modularized configuration such that it can be readily serviced and/or removed from the housing 11 and replaced in the event of malfunction. The air movement assembly 150 includes a housing which is generally indicated by the numeral 151. The housing includes a plurality of “squirrel cage” type fans 152 which are rotatably mounted in the housing 151 and which are operable to move ambient air along the air plenum 134 which is defined internally of the housing 11. The squirrel cage fans 152 which are mounted in the housing 151 are rotated by a motor which is not shown. As best seen in FIG. 5, it will be recognized that the squirrel cage fans are operable to move ambient air in a pattern along the air plenum 134 as seen by the arrows in FIG. 5. The air movement assembly 150 further includes an air mixing valve which is generally indicated by the numeral 153, and which can be seen in part in FIG. 6. The air mixing valve 153 is operable to selectively occlude the air plenum 134 thereby causing air moving along the air plenum 134 to be exhausted to ambient or further to be recycled along the air plenum 134 back through the plurality of fuel cell modules as will be discussed hereinafter. The air mixing valve 153 constitutes a moveable vane. An actuator 154 is provided and which, when energized, can move the air mixing valve 153 along a course of travel such that it may at least partially occlude the air plenum 134 and thus allow air circulating in the air plenum 134 to travel or be exhausted through aperture 53, and through the passageway 55 to ambient. As seen by reference to FIGS. 5 and 6, the air movement assembly also includes an air filter 155 which is positioned in substantially occluding relation relative to the second aperture 54. The air filter provides a means by which particulate matter may be removed from an ambient air stream 135 which is entering into the air plenum 134.

Referring now to FIG. 3, it will be seen that the fuel cell power system 10 includes an electronics bay which is generally indicated by the numeral 170 and which is covered, in part, by the second sidewall 30. As seen by reference to FIG. 1, the second sidewall 30, top surface 40, and the control panel 100 have been removed in order to show the structure thereunder. As will be seen, the electronics bay 170 includes, as a general matter, a reconfigurable control electronics assembly which is generally indicated by the numeral 171. This reconfigurable control electronics assembly includes a controller 172 which can be electrically coupled with, and be in controlling relation relative to three or fewer additional fuel cell power systems 11 such as seen in FIG. 4. Additionally, the reconfigurable control electronics assembly 171 includes a DC to DC converter 173, and inverter circuitry 174. The electrical output of the fuel cell power system 10 as effected by these subassemblies is then accessed by way of the power output terminals 72 or power output plug 73. In the arrangement as shown, the DC to DC converter 173 is electrically coupled with the reconfigurable control electronics assembly 171, and in the arrangement as seen in FIGS. 1-7, the DC to DC converter has a nominal output of about 24/48 volts DC depending upon how the reconfigurable control electronics assembly 171 is arranged. As earlier noted, the reconfigurable control electronics assembly 171 is electrically coupled to the plurality of modular jacks 64 such that the reconfigurable control electronics assembly 171 can be remotely monitored and/or further electrically coupled with other fuel cell power systems 10 in a master/slave arrangement as seen in FIG. 4. As should be understood with respect to FIG. 4, only one of the fuel cell power systems 10 has an electronics bay 170. This fuel cell power system 10 then controls the operation of three or fewer additional fuel cell power systems 10 as shown herein as mounted in a conventional communications rack.

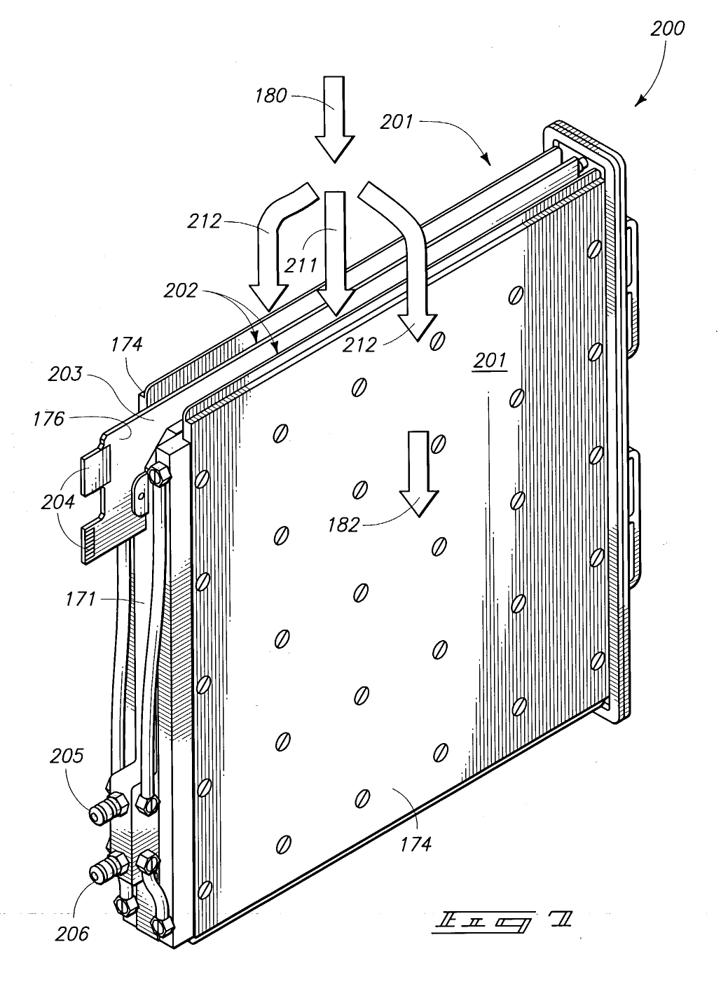

The typical fuel cell module enclosed within the housing 11 of the fuel cell power system 10 is best seen by reference to FIG. 7. This particular fuel cell module is described in significant detail in U.S. Pat. No. 6,468,682 and therefore for purposes of brevity is not described in significant detail herein. The teachings of this earlier patent are incorporated by reference. As a general matter, the fuel cell module 200 includes a pair of opposite anode heat sinks 201 which lie in heat removing relation relative to a plurality of membrane electrode diffusion layer assemblies (not shown) and which are enclosed within the fuel cell module. As seen in FIG. 7, the fuel cell module 200 includes a cathode air passageway which is generally indicated by the numeral 202. Still further, a current conductor assembly 203 is mounted on the fuel cell module and is operable to conduct the electricity generated by the fuel cell module 200 away from same when the fuel cell module is rendered operational. The current conductor assembly 203 includes a plurality of electrical contacts 204 which are operable to be received in current conducting relation relative to the electrical bus 144 which is supported on the rear wall portion 140 of the fuel cell module support frame 120. As seen in FIG. 7, the fuel cell module 200 includes a fluid intake coupler 205 which is operable to releasably mate in fluid flowing relation relative to one of the fluid couplers 142, and further has a fluid exhaust coupler 206 which is operable to releasably couple in fluid flowing relation relative to one of the fluid exhaust couplers 143 which are borne on the fuel cell module support frame 120. As will be seen by reference to FIG. 7, an ambient air flow or stream which is represented by the numeral 210 is supplied by way of the air plenum 134. The ambient airflow 210 is bifurcated into a first cathode air stream 211, which is received in the cathode air passageway 202, and a second anode heat sink air stream 212. As discussed in greater detail in U.S. Pat. No. 6,468,682, the teachings of which are incorporated by reference herein, the bifurcated ambient airflow 210 is operable to control the operational temperature of the fuel cell module and is further operable to exhaust heat energy generated by fuel cell module operation to ambient.

The fuel cell power system and more specifically, the housing 11 thereof, is operable to enclose at least five self-hydrating fuel cell modules 200. A fuel cell module as presently shown in FIG. 7 weighs less than about twelve pounds. Still further, and while the collective weight of all of the fuel cell modules are normally less than about 72 pounds, and occupies a space of less than about 1.2 cubic feet, the housing 11 occupies a space of less than about 8 cubic feet. Still further when completely assembled, the fuel cell power system 10 of the present invention delivers at least about 1,000 watts of electrical power to a load while weighing less than about 150 pounds. This makes the present fuel cell power system 10 quite attractive for use in remote locations and in other commercial or industrial environments where a heavier substantially fixed-plant fuel cell arrangement such as is shown in the prior art would not be useful. Yet further, because the present fuel cell power system 10 is self-hydrating and does not require any substantial balance of plant to render it operational, it is quite useful in a number of different environments where prior art stack-type fuel cells would have been impractical. Yet further, the reconfigurable control electronics assembly 171 is mounted in an advantageous location on the housing 11, and is further accessible from a location which is outside of the cavity 84. This is achieved by merely removing the second sidewall 30 of the housing 70. Thus, a technician may readily access, repair, and/or adjust the fuel cell power system 10 to deliver a wide range of power in a fashion not possible heretofore.

### OPERATION

The operation of the described embodiments of the present invention are believed to be readily apparent and are briefly summarized at this point.

The fuel cell power system 10 of the present invention includes a housing 11 defining an internal cavity 84; and a plurality of fuel cell modules 200 are received within the cavity 84 and which are electrically coupled together, and which provide, when operational, at least about a 1,000 watt electrical power output, and wherein the individual fuel cell modules 200 may be electrically decoupled from the remaining fuel cell modules and removed from the cavity 84, while the remaining fuel cell modules 200 continue to operate. The fuel cell power system 10 of the present invention weighs less than about 150 pounds.

More specifically, the fuel cell power system 10 of the present invention includes a housing 11 defining a cavity 84, and which includes an air plenum 134 which is coupled in fluid flowing relation relative to the cavity 84. An air movement assembly 150 is coupled in fluid flowing relation relative to the air plenum 134, and circulates ambient air through the cavity 84. A plurality of fuel cell modules 200 are operably received within the cavity 84 and which, when rendered operational, generate heat energy which is removed from the respective fuel cell modules 200 by way of the ambient air circulated through the air plenum 134. The respective fuel cell modules 200 each weigh less than about 12 pounds, and are electrically coupled together. The respective fuel cell modules 200 can be readily electrically decoupled, and removed from the cavity of the housing, while the remaining fuel cell modules 200 continue in operation. A DC to DC converter 173 is electrically coupled with the fuel cell modules 200 and with a load having a demand. Still further, an electrically reconfigurable, and inverter compatible, control electronics assembly 171 is borne by the housing 11 and which can be accessed from a location which lies outside of the cavity 84. The control electronics assembly 171 is coupled in controlling relation relative to the respective fuel cell modules 200, and with the DC to DC converter 173. The fuel cell power system further provides user controls 100 for initiating, terminating, and monitoring fuel cell power system 10 operation. The fuel cell power system 10 of the present invention delivers at least about 1,000 watts of electrical power to a load. The present invention and more specifically the housing thereof occupies a space of less than about 8 cubic feet and the total fuel cell power system weight weighs less than about 150 pounds. As noted earlier, the plurality of fuel cell modules collectively weigh less than about 72 pounds and occupy a space of less than about 1.2 cubic feet within the internal cavity of the housing 84.

Therefore it will be seen that the fuel cell power system 10 of the present invention has numerous advantages over the prior art techniques and teachings including the elimination of many balance of plant subassemblies typically utilized in stack-like fuel cell devices. Moreover, in view of the prior art teachings provided heretofore, the present system is lightweight, compact and provides numerous advantages in various commercial and industrial environments where the prior art fuel cell power system would have been difficult, if not impossible to deploy.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I/We claim:

1. A fuel cell power system, comprising:
a housing defining an internal cavity; and
a plurality of fuel cell modules received within the cavity and which are electrically coupled together, and which provide, when operational, at least about a 1000 watt electrical output, and wherein the individual fuel cell modules may be electrically decoupled from the remaining fuel cell modules and removed from the cavity, while the remaining fuel cell modules continue to operate, and wherein the fuel cell power system weighs less than about 150 pounds.

2. A fuel cell power system, as claimed in claim 1, and wherein at least five self hydrating fuel cell modules are enclosed within the housing, and wherein the respective fuel cell modules weigh less than about 12 pounds.

3. A fuel cell power system as claimed in claim 2, and wherein the housing has a size of less than about 8 cubic feet.

4. A fuel cell power system as claimed in claim 1, and further comprising:
a reconfigurable control electronics assembly electrically coupled to the individual fuel cell modules and which is further mounted on the housing, and which is accessible from a location that is outside of the cavity.

5. A fuel cell power system as claimed in claim 4, and further comprising:
a DC converter which is electrically coupled with the reconfigurable control electronics assembly and which has a nominal voltage output of about 48 volts DC.

6. A fuel cell power system as claimed in claim 4, and further comprising:
a DC converter which is electrically coupled with the reconfigurable electronics assembly and which has a nominal output of about 24/48 volts DC.

7. A fuel cell power system as claimed in claim 4, and wherein the reconfigurable control electronics assembly includes a controller which can be electrically coupled with, and be in controlling relation relative to three or fewer additional fuel cell power systems.

8. A fuel cell power system as claimed in claim 4, and wherein a plurality of fuel cell power systems may be electrically joined together by way of the respective reconfigurable control electronics assemblies to provide an increased power output to service electrical loads having various load demands.

9. A fuel cell power system as claimed in claim 4, and wherein the reconfigurable control electronics assembly is inverter compatible.

10. A fuel cell power system as claimed in claim 4, and wherein the plurality of fuel cell modules are self hydrating and air cooled.

11. A fuel cell power system as claimed in claim 4, and wherein the plurality of fuel cell modules are electrically coupled in serial relation to each other.

12. A fuel cell power system as claimed in claim 4, and wherein the plurality of fuel cell modules are electrically coupled in parallel relation to each other.

13. A fuel cell power system, comprising:
a housing defining a cavity, and which includes an air plenum which is coupled in fluid flowing relation relative to the cavity;
an air movement assembly coupled in fluid flowing relation relative to the air plenum, and which circulates ambient air through the cavity;
a plurality of fuel cell modules operably received within the cavity and which, when rendered operational, generate heat energy which is removed from the respective fuel cell modules by way of the ambient air circulated through the air plenum, and wherein the respective fuel cell modules weigh less than about 12 pounds each, and are electrically coupled together, and wherein the respective fuel cell modules can be readily electrically decoupled, and removed from the cavity of the housing, while the remaining fuel cell modules continue in operation;
a DC to DC converter borne by the housing and which is electrically coupled with the respective fuel cell modules and with a load having a demand; and
an electrically reconfigurable, and inverter compatible, control electronics assembly which is borne by the housing and which can be accessed from a location which is outside of the cavity, and wherein the control electronics assembly is coupled in controlling relation relative to the respective fuel cell modules, and with the DC to DC converter, and which further provides user controls for initiating, terminating, and monitoring fuel cell power system operation, and wherein the fuel cell power system delivers at least about 1000 watts of electrical power to the load.

14. A fuel cell power system as claimed in claim 13, and wherein the housing has size of less than about 8 cubic feet.

15. A fuel cell power system as claimed in claim 13, and wherein the fuel cell power system weighs less than about 150 pounds.

16. A fuel cell power system as claimed in claim 13, and wherein the control electronics assembly includes a controller which can be electrically coupled with, and be in controlling relation relative to three or fewer additional fuel cell power systems.

17. A fuel cell power system as claimed in claim 13, and wherein a plurality of fuel cell power systems may be electrically joined together by way of the respective reconfigurable control electronics assemblies to provide an increased power output to service electrical loads having various load demands.

18. A fuel cell power system, comprising:
a housing defining an internal cavity and which is operable to move ambient air in a predetermined circulation pattern within the internal cavity, and wherein the housing occupies a space of less than about 8 cubic feet;
a plurality of fuel cell modules which are received within the cavity of the housing and which, when rendered operational, produces an electrical power output of less than about 1000 watts, and heat energy, and wherein the ambient air circulating in the housing has the effect of removing a preponderance of the heat energy from the plurality of fuel cell modules and delivering the heat energy to ambient, and wherein the plurality of fuel cell modules collectively weigh less than about 72 pounds and occupy a space of less than about 1.2 cubic feet within the internal cavity of the housing;
a DC to DC converter borne by the housing and electrically coupled with the respective fuel cell modules and with a load having a demand; and
an electrically reconfigurable and inverter compatible, control electronics assembly which is borne by the housing and which is coupled in controlling relation relative to the respective fuel cell modules, and which further can be electrically coupled with at least one other fuel cell power system, and wherein the fuel cell power system weighs less than about 150 pounds.

19. A fuel cell power system as claimed in claim 18, and wherein the plurality of fuel cell modules includes at least five substantially self hydrating fuel cell modules.

20. A fuel cell power system as claimed in claim 18, and wherein the plurality of fuel cell modules can be readily electrically decoupled and removed from the housing while the remaining fuel cell modules continue to operate.

21. A fuel cell power system as claimed in claim 18, and wherein the plurality of fuel cell modules are serially electrically coupled together.

22. A fuel cell power system as claimed in claim 18, and wherein the plurality of fuel cell modules are electrically coupled in parallel relation, one to the others.
